(19) United States
(12) Patent Application Publication
(10) Pub. No.: US 2018/0326557 A1
(43) Pub. Date: Nov. 15, 2018

(54) BONDED ABRASIVE ARTICLE AND METHOD OF MAKING THE SAME

(71) Applicant: 3M INNOVATIVE PROPERTIES COMPANY, St Paul, MN (US)

(72) Inventors: Melissa C. Schillo-Armstrong, Stillwater, MN (US); Brian D. Goers, Minneapolis, MN (US); Joseph B. Eckel, Vadnais Heights, MN (US)

(21) Appl. No.: 15/775,561

(22) PCT Filed: Nov. 8, 2016
(86) PCT No.: PCT/US2016/060906

§ 371 Date: May 11, 2018

Related U.S. Application Data
(60) Provisional application No. 62/254,872, filed on Nov. 13, 2015.

(51) Int. Cl. B24D 18/00; B24D 3/14; B24D 3/28; C09K 3/14

(52) U.S. Cl. CPC B24D 18/0009; B24D 3/14; B24D 2203/00; C09K 3/1418; B24D 3/28

(57) ABSTRACT

A method of making a bonded abrasive article comprises urging crushed abrasive particles with agitation against the surface of a tool, thereby causing a first portion of crushed abrasive particles to become retained within horizontally-oriented precisely-shaped cavities at predetermined locations with respect to the surface of the tool, and causing a second portion of the crushed abrasive particles to remain as loose particles on the surface of the tool. The loose particles are separated from the tool. The tool is positioned within a mold containing a curable binder material precursor. The crushed abrasive particles retained in the precisely-shaped cavities into the mold are released, and the tool is removed from the mold. The crushed abrasive particles and the curable binder material precursor are shaped and cured to form the bonded abrasive article. A bonded abrasive article preparable by the method is also disclosed.

### TECHNICAL FIELD

The present disclosure broadly relates to bonded abrasive articles and methods of making them.

### BACKGROUND

Crushed abrasive particles or grains are formed by mechanically crushing abrasive mineral. Due to the random nature of the crushing operation, the resultant particles are typically randomly shaped and sized. Ordinary, initially produced crushed abrasive particles are sorted by size for use later use in various abrasive products such as, for example, bonded abrasive articles.

Bonded abrasive articles have abrasive particles bonded together by a bonding medium. For resin-bond (i.e., organic resin-bonded) abrasives the bonding medium is a cured organic resin (optionally containing fillers, etc.). For vitreous-bond (i.e., vitreous-bonded) abrasives the bonding medium is a sintered inorganic material (optionally containing fillers, etc.) such as a ceramic or glass. Bonded abrasives include, for example, hones and bonded abrasive wheels such as grindstones and cutoff wheels.

Cutoff wheels are typically thin wheels used for general cutting operations. The wheels are typically about 2 to about 200 centimeters in diameter, and from less than one millimeter (mm) to several mm thick. They are typically operated at speeds of from about 1000 to about 50000 revolutions per minute, and are used for operations such as cutting metal or glass, for example, to a nominal length. Cutoff wheels are also known as “industrial cutoff saw blades” and, in some settings such as foundries, as “chop saws”. As their name implies, cutoff wheels are used to cut stock such as, for example, metal rods and pipe by abrading through the stock.

There continues to be a need for higher performing bonded abrasive articles and methods for making them.

### SUMMARY

The present disclosure advances the art of bonded abrasive articles.

In a first aspect, the present disclosure provides a method of making a bonded abrasive article, the method comprising sequentially performing steps:

a) providing a tool having first and second opposed horizontal major surfaces, the first major surface defining precisely-shaped cavities, wherein each horizontally-oriented precisely-shaped cavity has a predetermined location with respect to the surface of the tool, wherein each precisely-shaped cavity has a horizontal bottom surface with a respective conduit opening fluidly connected to a vacuum source;

b) urging first crushed abrasive particles with agitation against the surface of the tool, thereby causing a portion of the first crushed abrasive particles to become retained within at least some of the precisely-shaped cavities and causing a second portion of the first crushed abrasive particles to remain as first loose particles on the surface of the tool;

c) separating substantially all of the first loose particles from the tool;

d) positioning the tool within a mold containing a curable binder material precursor and;

e) releasing the first crushed abrasive particles retained in the precisely-shaped cavities into the mold;

f) removing the tool from the mold;

g) compressing the first crushed abrasive particles and the curable binder material precursor to form a shaped green body; and

g) at least partially curing the curable binder material precursor to produce the bonded abrasive article.

In some embodiments, the method further comprises, after step e) and prior to step f), sequentially performing steps:

i) urging second crushed abrasive particles with agitation against the surface of the tool, thereby causing a portion of the second crushed abrasive particles to become retained within at least some of the precisely-shaped cavities and causing a portion of the second crushed abrasive particles to remain as second loose particles on the surface of the tool, wherein substantially all of the precisely-shaped cavities contain at most one second crushed abrasive particle;

ii) separating the second loose particles from the tool;

iii) adding an additional amount of the curable binder material precursor into the mold;

iv) positioning the tool within the mold; and

iv) releasing the second crushed abrasive particles retained in the precisely-shaped cavities into the mold.

In another aspect, the present disclosure provides a bonded abrasive article comprising crushed abrasive particles securely retained in a binder material, wherein the crushed abrasive particles are disposed at predetermined locations in the bonded abrasive article.

In some embodiments, the crushed abrasive particles are arranged according to a regular pattern. In some embodiments, the crushed abrasive particles have a non-random orientation.

As used herein, the term “horizontally-oriented” in reference to cavities means having a length and width locally parallel to the surface of the tool that defines them.

As used herein, the term “precisely-shaped” in reference to cavities in a tool refers to cavities having three-dimensional shapes that are defined by relatively smooth-surfaced sides that are bounded and joined by well-defined sharp edges having distinct edge lengths with distinct endpoints defined by the intersections of the various sides.

Features and advantages of the present disclosure will be further understood upon consideration of the detailed description as well as the appended claims.

### BRIEF DESCRIPTION OF THE DRAWINGS

FIG. 1A is a perspective view of an exemplary bonded abrasive cutoff wheel 100 according to one embodiment of the present disclosure;

FIG. 1B is a cross-sectional side view of exemplary bonded abrasive cutoff wheel shown in FIG. 1 taken along line 1B-1B;

FIG. 2A is a schematic top view of an exemplary tool 210 suitable for practicing the present disclosure.

FIG. 2B is an enlarged cross-sectional view of a cavity 220 shown in FIG. 2A.

It should be understood that numerous other modifications and embodiments can be devised by those skilled in the art, which fall within the scope and spirit of the principles of the disclosure. The figures may not be drawn to scale.

### DETAILED DESCRIPTION

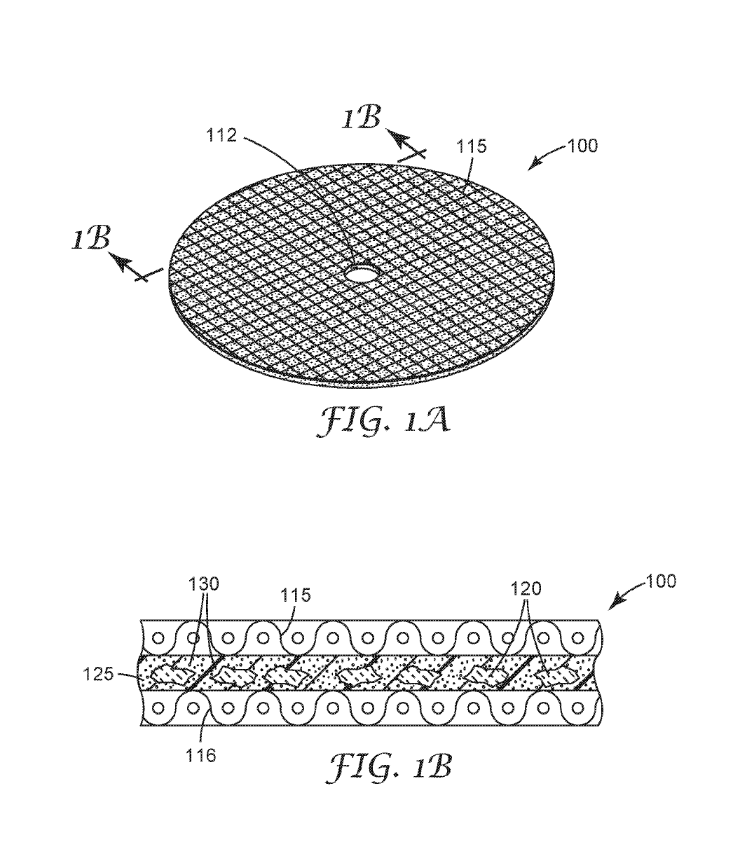

Referring now to FIG. 1A, exemplary bonded abrasive cutoff wheel 100 according to one embodiment of the present disclosure has center hole 112 used for attaching cutoff wheel 100 to, for example, a power driven tool. Referring now to FIG. 1B, which is a cross-section of cutoff wheel 100 in FIG. 1A taken along line 1B-1B, showing crushed abrasive particles 120, optional filler particles 130, and binder material 125. Cutoff wheel 100 has first scrim 115 and second scrim 116, which are disposed on opposite major surfaces of cutoff wheel 100. Crushed abrasive particles 120 may be positioned at predetermined locations.

The bonded abrasive wheels according to the present disclosure are generally made by a molding process. During molding, an organic binder material precursor is mixed with the abrasive particles. In some instances, a liquid medium (either resin or a solvent) is first applied to the abrasive particles to wet their outer surface, and then the wetted particles are mixed with a powdered medium. Bonded abrasive wheels according to the present disclosure may be made by compression molding, injection molding, transfer molding, or the like. The molding can be done either by hot or cold pressing or any suitable manner known to those skilled in the art.

When cured, the organic binder material is typically included in an amount of from 5 to 30 percent, more typically 10 to 25, and more typically 15 to 24 percent by weight, based of the total weight of the bonded abrasive article. Phenolic resin is the most commonly used organic binder material, and may be used in both the powder form and liquid state. Although phenolic resins are widely used, it is within the scope of this disclosure to use other organic binder materials including, for example, epoxy resins, urea-formaldehyde resins, rubbers, shellacs, and acrylic binders. The organic binder material may also be modified with other binder materials to improve or alter the properties of the organic binder material.

Useful phenolic resins include novolac and resole phenolic resins. Novolac phenolic resins are characterized by being acid-catalyzed and having a ratio of formaldehyde to phenol of less than one, typically between 0.5:1 and 0.8:1. Resole phenolic resins are characterized by being alkaline catalyzed and having a ratio of formaldehyde to phenol of greater than or equal to one, typically from 1:1 to 3:1. Novolac and resole phenolic resins may be chemically modified (e.g., by reaction with epoxy compounds), or they may be unmodified. Exemplary acidic catalysts suitable for curing phenolic resins include sulfuric, hydrochloric, phosphoric, oxalic, and p-toluenesulfonic acids. Alkaline catalysts suitable for curing phenolic resins include sodium hydroxide, barium hydroxide, potassium hydroxide, calcium hydroxide, organic amines, or sodium carbonate.

Phenolic resins are well-known and readily available from commercial sources. Examples of commercially available novolac resins include DUREZ 1364, a two-step, powdered phenolic resin (marketed by Durez Corporation of Addison, Tex. under the trade designation VARCUM (e.g., 29302), or HEXION AD5534 RESIN (marketed by Hexion Specialty Chemicals, Inc. of Louisville, Ky.). Examples of commercially available resole phenolic resins useful in practice of the present disclosure include those marketed by Durez Corporation under the trade designation VARCUM (e.g., 29217, 29306, 29318, 29338, 29353); those marketed by Ashland Chemical Co. of Bartow, Fla. under the trade designation AEROFENE (e.g., AEROFENE 295); and those marketed by Kangnam Chemical Company Ltd. of Seoul, South Korea under the trade designation “PHENOLITE” (e.g., PHENOLITE TD-2207).

Curing temperatures of organic binder material precursors will vary with the material chosen and wheel design. Selection of suitable conditions is within the capability of one of ordinary skill in the art. Exemplary conditions for a phenolic binder may include an applied pressure of about 20 tons per 4 inches diameter (224 kg/cm²) at room temperature followed by heating at temperatures up to about 185° C. for sufficient time to cure the organic binder material precursor.

In some embodiments, the bonded abrasive articles include from about 10 to 70 percent by weight of crushed abrasive particles; typically 30 to 60 percent by weight, and more typically 40 to 60 percent by weight, based on the total weight of the binder material and abrasive particles.

The tool may have any suitable form. Examples include drums, endless belts, discs, and sheets. The tool may be rigid or flexible, but preferably is sufficiently flexible to permit use of normal web handling devices such as rollers. Suitable materials for fabricating the tool include, for example, thermoplastics (e.g., polyethylene, polypropylene, polycarbonate, polyimide, polyester, polyamides, acrylonitrile-butadiene-styrene plastic (ABS), polyethylene terephthalate (PET), polybutylene terephthalate (PET), polyimides, polyetheretherketone (PEEK), polyetherketone (PEK), and polyoxymethylene plastic (POM, acetal), poly(ether sulfone), poly(methyl methacrylate), polyurethanes, polyvinyl chloride, and combinations thereof), metal, and natural, EPDM and/or silicone rubber. Commercially available suitable materials include those suitable for use with 3D printers such as, for example, those marketed by 3D Systems, Rock Hill, S.C., under the trade designations “VISIJET SL”, and “ACCURA” (e.g., Accura 60 plastic).

Useful tools have precisely-shaped cavities, which may be of any precise shape or size. Examples of suitable cavity shapes include: 3-, 4-, 5-, and 6-sided prisms (i.e., not including the base and top) and pyramids (e.g., 3-sided prisms and pyramids with isosceles and obtuse triangle bases). In some embodiments, the cavities are equilateral triangular or tetragonal prisms or pyramids. In some embodiments, the cavities are cones. The above pyramidal and conical shapes may also be truncated.

The average aspect ratio of the longitudinal axes of the cavities (i.e., the ratio of length:width) is at least 1.2. Preferably, the average aspect ratio is at least 1.2, at least 1.25, at least 1.3, at least 1.35, or at least 1.4, or more.

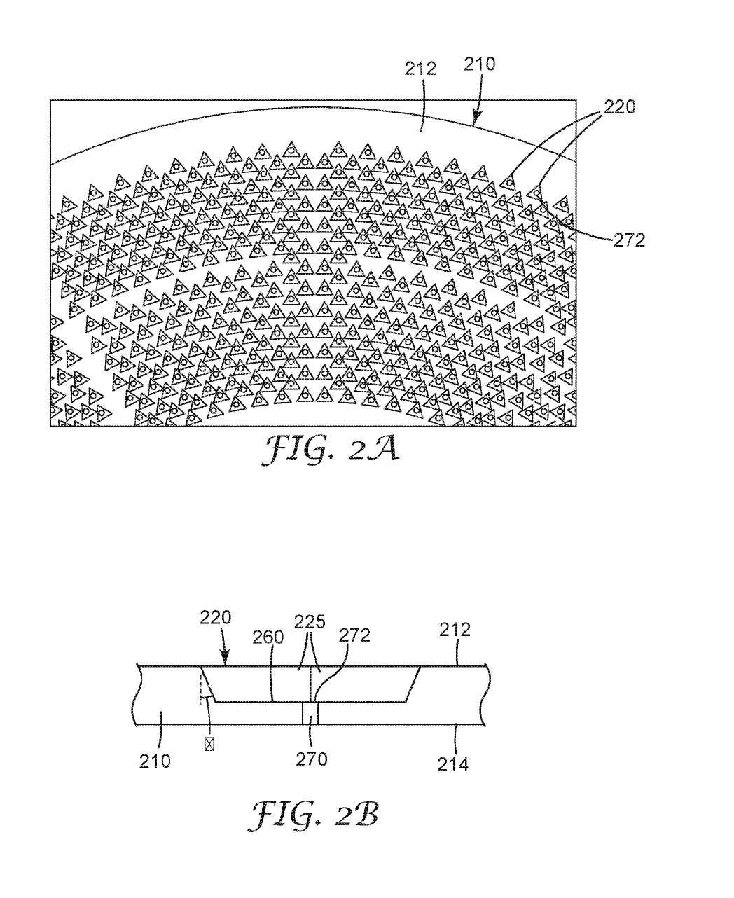

Referring now to FIG. 2A, exemplary tool 210 has first and second opposed major surfaces 212, 214 (see FIG. 2B). Surface 212 defines a plurality of identical horizontally-oriented precisely-shaped cavities 220 disposed on surface 212. As shown in FIG. 2B, precisely-shaped cavities 220 are shaped as truncated equilateral triangular pyramids having sidewalls 225 with an inward taper angle θ and a planar bottom 260, except for openings 272 of conduits 270 that extend through tool 210 to second surface 214. In use, these openings are fluidly connected to a low pressure source such as, for example, a vacuum pump (not shown) in order to retain crushed abrasive particles in the cavities during positioning of the tool and crushed abrasive particles in the mold (typically in an inverted tool configuration with the cavities facing downward). Eliminating the applied vacuum (e.g., increasing the pressure to ambient pressure) releases the crushed abrasive particles to fall into the mold in where they are fixed in position.

Unexpectedly, the present inventors found that by using horizontally-oriented precisely shaped cavities with an aspect ratio of at least 1.2 can result in crushed abrasive particles with larger than average aspect ratios being preferentially retained in the cavities, and hence incorporated into the bonded abrasive article. Moreover, as the crushed abrasive particles retained in the cavities are generally oriented to at least some degree by the cavities, which orientation may be incorporated into the bonded abrasive article.

The openings of the cavities may have any shape. The length, width, and depth of the cavities in the carrier member will generally be determined at least in part by the shape and size of the crushed abrasive particles with which they are to be used. In order for crushed abrasive particles to reside in the horizontally-oriented cavities, the length of the cavity opening should be larger (e.g., at least 10, 20, 30, 40, or even 50 percent larger) than the average particle diameter of the crushed abrasive particles, while the depths and widths of the cavities are preferably less than the average particle diameter of the crushed abrasive particles. In practice of the present disclosure, it is preferable that substantially all of the shaped cavities contain at most one abrasive particle.

Methods according to the present disclosure may result in bonded abrasive articles containing abrasive particles with a higher average aspect ratio (length to width) than was present in the crushed abrasive particles prior to shape sorting. The degree of enhancement may vary depending, for example, on the shape of the cavities in the tool, and their relation to the size and shape of the crushed abrasive particles. For example, cavities that are too small in one or more dimensions will not be able to retain an abrasive particle, especially with agitation, within a cavity. Likewise, cavities that are overly large relative to the abrasive particles being sorted may result in reduced effectiveness with respect to shape sorting. The degree of agitation needed to properly sort the particles into the cavities may also vary depending on the size and/or shape of the cavities and the abrasive particles. Accordingly, these parameters will typically vary with the crushed abrasive particles and tool that are selected. Selection of both such parameters are within the capability of those skilled in the art.

The tool can be in the form of, for example, an endless belt, a sheet, a continuous sheet or web, a coating roll, a sleeve mounted on a coating roll, or die. If the tool is in the form of a belt, sheet, web, or sleeve, it will have a contacting surface and a non-contacting surface. The pattern of the contacting surface of the production tool will generally be characterized by a plurality of cavities or recesses. The pattern formed by the cavities can be arranged according to a specified plan or can be random. While the cavities may be arranged in a regular array, to maximize surface are coverage, they may also be randomly oriented, as once the crushed abrasive particles are removed from the cavities they lose all spatial orientation relation to each other crushed abrasive particles.

Further details concerning methods for making tools useful for practicing practice the present disclosure are described in PCT Intl. Publ. No. WO 2012/100018 A1 (Culler et al.) and U.S. Pat. Appln. Publ. 2013/0344786 A1 (Keipert).

The precisely-shaped cavities may have a second opening at the bottom of each cavity extending to a second surface opposite the surface defining the cavities. In such cases, the second opening is preferably sufficiently smaller than the first opening such that the abrasive particles do not pass completely through both openings (i.e., the second opening is small enough to prevent passage of the abrasive particles through the carrier member).

The tool has horizontally oriented cavities. For example, in one embodiment, shown in FIG. 2A, tool 210 has cavities 220 defined by surface 212. Major surface 212 has a plurality of identical precisely-shaped (as truncated triangular pyramids) cavities 220 formed therein. Cavities 220 are relatively shallow (they have a depth less than both of the length and width) and are arranged parallel to surface 212. Each cavity 220 has a hole 270 (see FIG. 2B) at its bottom 260 through which vacuum can be applied.

The cavity sidewalls are preferably smooth, although this is not a requirement. The sidewalls may be planar, curviplanar (e.g., concave or convex), conical, or frustoconical, for example. The cavities may have a discrete bottom surface (e.g., a planar bottom parallel to the tool surface) or the sidewalls may meet at a point or a line, for example. Side walls of the cavities may be vertical (i.e., perpendicular to the surface of the tool) or tapered inward, for example.

In some embodiments, at least some of the cavities comprise first, second, third, and fourth sidewalls. In such embodiments, the first, second, third, and fourth side walls may be consecutive and contiguous.

The crushed abrasive particles are typically randomly shaped due to the nature of mechanical crushing. The abrasive particles generally are formed of mineral have a Mohs hardness of at least 4, 5, 6, 7 or even at least 8. Examples of suitable minerals include fused aluminum oxide (which includes brown aluminum oxide, heat treated aluminum oxide, and white aluminum oxide), co-fused alumina-zirconia, ceramic aluminum oxide, green silicon carbide, black silicon carbide, chromia, zirconia, flint, cubic boron nitride, boron carbide, garnet, sintered alpha-alumina-based ceramic, and combinations thereof. Sintered alpha-alumina-based ceramic abrasive granules are described, for example, by U.S. Pat. No. 4,314,827 (Leitheiser et al.) and in U.S. Pat. Nos. 4,770,671 and 4,881,951 (both to Monroe et al.). The alpha-alumina-based ceramic abrasive may also be seeded (with or without modifiers) with a nucleating material such as iron oxide or alpha-alumina particles as disclosed by Schwabel, U.S. Pat. No. 4,744,802 (Schwabel). The term “alpha-alumina-based ceramic abrasive granules” as herein used is intended to include unmodified, modified, seeded and unmodified, and seeded and modified ceramic granules.

Crushed abrasive particles are generally graded to a given particle size distribution before use. Such distributions typically have a range of particle sizes, from coarse particles to fine particles. In the abrasive art this range is sometimes referred to as a “coarse”, “control”, and “fine” fractions. Abrasive particles graded according to abrasive industry accepted grading standards specify the particle size distribution for each nominal grade within numerical limits. Such industry accepted grading standards (i.e., abrasives industry specified nominal grade) include those known as the American National Standards Institute, Inc. (ANSI) standards, Federation of European Producers of Abrasive Products (FEPA) standards, and Japanese Industrial Standard (JIS) standards.

ANSI grade designations (i.e., specified nominal grades) include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. FEPA grade designations include P8, P12, P16, P24, P36, P40, P50, P60, P80, P100, P120, P150, P180, P220, P320, P400, P500, P600, P800, P1000, and P1200. JIS grade designations include JIS8, JIS12, JIS16, JIS24, JIS36, JIS 46, JIS 54, JIS 60, JIS 80, JIS 100, JIS 150, JIS 180, JIS 220, JIS 240, JIS 280, JIS 320, JIS 360, JIS 400, JIS 600, JIS 800, JIS 1000, JIS 1500, JIS 2500, JIS 4000, JIS 6000, JIS8000, and JIS 10000.

Alternatively, crushed abrasive particles can graded to a nominal screened grade using U.S.A. Standard Test Sieves conforming to ASTM E-11 “Standard Specification for Wire Cloth and Sieves for Testing Purposes”. ASTM E-11 proscribes the requirements for the design and construction of testing sieves using a medium of woven wire cloth mounted in a frame for the classification of materials according to a designated particle size. A typical designation may be represented as −18+20 meaning that the abrasive particles through a test sieve meeting ASTM E-11 specifications for the number 18 sieve and are retained on a test sieve meeting ASTM E-11 specifications for the number 20 sieve. In one embodiment, the crushed abrasive particles have a particle size such that most of the particles pass through an 18 mesh test sieve and can be retained on a 20, 25, 30, 35, 40, 45, or 50 mesh test sieve. In various embodiments of the disclosure, the crushed abrasive particles can have a nominal screened grade comprising: −18+20, −20+25, −25+30, −30+35, −35+40, −40+45, −45+50, −50+60, −60+70, −70+80, −80+100, −100+120, −120+140, −140+170, −170+200, −200+230, −230+270, −270+325, −325+400, −400+450, −450+500, or −500+635.

Once the crushed abrasive particles are disposed onto the surface of the tool, they are agitated and gradually some of the particles settle into the cavities on the surface of the tool, while others remain loose on its surface. It will be recognized that a particle may alternately reside in and out of a cavity due to agitation, but that on average the crushed abrasive particles will tend toward an equilibrium state in which crushed abrasive particles with complementary sizes and shapes to the cavities will be preferentially retained in them.

Agitation of the crushed abrasive particles while in contact with the tool may be accomplished by any suitable means. Examples include mechanical agitation of the tool (e.g., using vibrating motors) and/or blowing air.

Once the crushed abrasive particles have at least partially (preferably completely) reached equilibrium in settling into the cavities on the surface of the tool, the excess loose crushed abrasive particles that remain on the surface of the tool are separated from the tool (and therefore also the abrasive particles residing in its cavities). This may be accomplished by any suitable means. Examples include inclining the surface of the tool such that gravity urges the loose particles away from the tool, wiping with a brush, and blowing air.

After excess loose crushed abrasive particles on the tool have been removed, the abrasive particles are separated from the tool, for example, by inverting the cavities and discontinuing the vacuum assist so that gravity causes them to fall out into a mold used to assembly the bonded abrasive article.

In one method of making a bonded abrasive article according to the present disclosure, an adhesive-coated reinforcing scrim is placed in the bottom of a 4-part mold and then crushed abrasive particles retained in precisely shaped cavities of a tool are released onto the adhesive-coated reinforcing scrim as described above. Binder material precursor (e.g., in liquid, slurry, paste, or powder form) is then added to the mold. Additional iterations of adding abrasive particles and curable binder material precursor may be carried out; for example, to build thickness of the resultant bonded abrasive article. A second reinforcing scrim is optionally but preferably added as the final component in the mold, which is then pressed to form a green body. The mold is removed and the green body is subjected to curing of the binder material precursor. Curing conditions will depend on the binder material precursor selected, and will be within the capability of those of skill in the art. Details concerning methods for making bonded abrasive articles can be found, for example, in U.S. Pat. No. 4,800,685 (Haynes et al.); U.S. Pat. No. 4,898,597 (Hay et al.); U.S. Pat. No. 4,933,373 (Moren); U.S. Pat. No. 5,282,875 (Wood et al.) and in U.S. Pat. Appln. Publ. 2011/0296767 A1 (Lee et al.).

Bonded abrasive wheels according to the present disclosure may contain additional components such as, for example, filler particles, subject to weight range requirements of the other constituents being met. Filler particles may be added to aid grinding, to occupy space, and/or provide porosity. Porosity enables the bonded abrasive wheel to shed used or worn abrasive particles to expose new or fresh abrasive particles.

Bonded abrasive wheels according to the present disclosure have any range of porosity; for example, from about 1 percent to 50 percent, typically 1 percent to 40 percent by volume. Examples of fillers include potassium aluminum fluorinate, sulfites, cryolite, bubbles and beads (e.g., glass, ceramic (alumina), clay, polymeric, metal), carbonates, cork, gypsum, marble, limestone, flint, silica, aluminum silicate, and combinations thereof.

Bonded abrasive wheels according to the present disclosure can be made according to any suitable method. In one suitable method, the non-seeded sol-gel derived alumina-based abrasive particles are coated with a coupling agent prior to mixing with the curable resole phenolic. The amount of coupling agent is generally selected such that it is present in an amount of 0.1 to 0.3 parts for every 50 to 84 parts of abrasive particles, although amounts outside this range may also be used. To the resulting mixture is added the liquid resin, as well as the curable novolac phenolic resin and the cryolite. The mixture is pressed into a mold (e.g., at an applied pressure of 20 tons per 4 inches diameter (224 kg/cm²) at room temperature. The molded wheel is then cured by heating at temperatures up to about 185° C. for sufficient time to cure the curable phenolic resins.

Coupling agents are well-known to those of skill in the abrasive arts. Examples of coupling agents include trialkoxysilanes (e.g., gamma-aminopropyltriethoxysilane), titanates, and zirconates.

Bonded abrasive wheels according to the present disclosure are useful, for example, as cutoff wheels and abrasives industry Type 27 (e.g., as in American National Standards Institute standard ANSI B7.1-2000 (2000) in section 1.4.14) depressed-center grinding wheels.

Cutoff wheels are typically 0.80 millimeter (mm) to 16 mm in thickness, more typically 1 mm to 8 mm, and typically have a diameter between 2.5 cm and 100 cm (40 inches), more typically between about 7 cm and 13 cm, although other dimensions may also be used (e.g., wheels as large as 100 cm in diameter are known). An optional center hole may be used to attaching the cutoff wheel to a power driven tool. If present, the center hole is typically 0.5 cm to 2.5 cm in diameter, although other sizes may be used. The optional center hole may be reinforced; for example, by a metal flange. Alternatively, a mechanical fastener may be axially secured to one surface of the cutoff wheel. Examples include threaded posts, threaded nuts, Tinnerman nuts, and bayonet mount posts.

Bonded abrasive wheels, and especially cutoff wheels, according to the present disclosure may include a reinforcing scrim that reinforces the bonded abrasive wheel; for example, disposed on one or two major surfaces of the bonded abrasive wheel, or disposed within the bonded abrasive wheel. Examples of reinforcing scrims include a woven or a knitted cloth. The fibers in the reinforcing scrim may be made from glass fibers (e.g., fiberglass), organic fibers such as polyamide, polyester, or polyimide. In some instances, it may be desirable to include reinforcing staple fibers within the bonding medium, so that the fibers are homogeneously dispersed throughout the cutoff wheel. The reinforcing scrim may be coated with an adhesive to aid in retaining the position of the crushed abrasive particles when they are deposited in the mold.

Bonded abrasive wheels according to the present disclosure are useful, for example, for abrading a workpiece. For example, they may be formed into grinding or cutoff wheels that exhibit good grinding characteristics while maintaining a relatively low operating temperature that may avoid thermal damage to the workpiece.

Cutoff wheels can be used on any right angle grinding tool such as, for example, those available from Ingersoll-Rand, Sioux, Milwaukee, and Dotco. The tool can be electrically or pneumatically driven, generally at speeds from about 1000 to 100000 RPM, although this is not a requirement.

During use, the bonded abrasive wheel can be used dry or wet. During wet grinding, the wheel is used in conjunction with water, oil-based lubricants, or water-based lubricants. Bonded abrasive wheels according to the present disclosure may be particularly useful on various workpiece materials such as, for example, carbon steel sheet or bar stock and more exotic metals (e.g., stainless steel or titanium), or on softer more ferrous metals (e.g., mild steel, low alloy steels, or cast irons).

Objects and advantages of this disclosure are further illustrated by the following non-limiting examples, but the particular materials and amounts thereof recited in these examples, as well as other conditions and details, should not be construed to unduly limit this disclosure.

### Select Embodiments of the Present Disclosure

In a first embodiment, the present disclosure provides a method of making a bonded abrasive article, the method comprising sequentially performing steps:

a) providing a tool having first and second opposed horizontal major surfaces, the first major surface defining precisely-shaped cavities, wherein each horizontally-oriented precisely-shaped cavity has a predetermined location with respect to the surface of the tool, wherein each precisely-shaped cavity has a horizontal bottom surface with a respective conduit opening fluidly connected to a vacuum source;

b) urging first crushed abrasive particles with agitation against the surface of the tool, thereby causing a portion of the first crushed abrasive particles to become retained within at least some of the precisely-shaped cavities and causing a second portion of the first crushed abrasive particles to remain as first loose particles on the surface of the tool;

c) separating substantially all of the first loose particles from the tool;

d) positioning the tool within a mold containing a curable binder material precursor and optionally a first reinforcing scrim;

e) releasing the first crushed abrasive particles retained in the precisely-shaped cavities into the mold;

f) removing the tool from the mold;

g) compressing the first crushed abrasive particles and the curable binder material precursor to form a shaped green body; and

g) at least partially curing the curable binder material precursor to produce the bonded abrasive article.

In a second embodiment, the present disclosure provides a method according to the first embodiment further comprising, after step e) and prior to step g), placing a second reinforcing scrim within the mold.

In a third embodiment, the present disclosure provides a method according to the first or second embodiment, further comprising contacting wherein the precisely-shaped cavities are horizontally-oriented.

In a fourth embodiment, the present disclosure provides a method according to any of the first to third embodiments, wherein substantially all of the horizontally-oriented precisely-shaped cavities contain at most one of the first crushed abrasive particles.

In a fifth embodiment, the present disclosure provides a method according to any one of the first to fourth embodiments further comprising, after step e) and prior to step f), sequentially performing steps:

i) urging second crushed abrasive particles with agitation against the surface of the tool, thereby causing a portion of the second crushed abrasive particles to become retained within at least some of the precisely-shaped cavities and causing a portion of the second crushed abrasive particles to remain as second loose particles on the surface of the tool, wherein substantially all of the precisely-shaped cavities contain at most one second crushed abrasive particle;

ii) separating the second loose particles from the tool;

iii) adding an additional amount of the curable binder material precursor into the mold;

iv) positioning the tool within the mold; and

iv) releasing the second crushed abrasive particles retained in the precisely-shaped cavities into the mold.

In a sixth embodiment, the present disclosure provides a method according to any one of the first to fifth embodiments, wherein the mold further contains a second reinforcing scrim.

In a seventh embodiment, the present disclosure provides a method according to any one of the first to sixth embodiments, wherein step b) comprises mechanically agitating the tool.

In an eighth embodiment, the present disclosure provides a method according to any one of the first to seventh embodiments, wherein the first crushed abrasive particles conform to an abrasives industry specified nominal grade prior to disposing them on the surface of the tool.

In a ninth embodiment, the present disclosure provides a method according to the eighth embodiment, wherein the abrasives industry specified nominal grade is selected from the group consisting of ANSI grade designations ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600; FEPA grade designations P8, P12, P16, P24, P36, P40, P50, P60, P80, P100, P120, P150, P180, P220, P320, P400, P500, P600, P800, P1000, and P1200; and JIS grade designations JIS8, JIS12, JIS16, JIS24, JIS36, JIS 46, JIS 54, JIS 60, JIS 80, JIS 100, JIS 150, JIS 180, JIS 220, JIS 240, JIS 280, JIS 320, JIS 360, JIS 400, JIS 600, JIS 800, JIS 1000, JIS 1500, JIS 2500, JIS 4000, JIS 6000, JIS8000, and JIS 10000.

In a tenth embodiment, the present disclosure provides a method according to any one of the first to ninth embodiments, wherein the crushed abrasive particles comprise at least one of fused aluminum oxide, co-fused alumina-zirconia, ceramic aluminum oxide, green silicon carbide, black silicon carbide, chromia, zirconia, flint, cubic boron nitride, boron carbide, garnet, sintered alpha-alumina-based ceramic, and combinations thereof.

In an eleventh embodiment, the present disclosure provides a method according to any one of the first to tenth embodiments, wherein the first crushed abrasive particles have an average particle diameter D₅₀ of at least 0.1 millimeter.

In a twelfth embodiment, the present disclosure provides a method according to any one of the first to eleventh embodiments, wherein the bonded abrasive article comprises a cutoff wheel.

In a thirteenth embodiment, the present disclosure provides a method according to any one of the first to twelfth embodiments, wherein the curable binder material precursor comprises a curable organic resin.

In a fourteenth embodiment, the present disclosure provides a bonded abrasive article comprising crushed abrasive particles securely retained in a binder material, wherein the crushed abrasive particles are disposed at predetermined locations in the bonded abrasive article.

In a fifteenth embodiment, the present disclosure provides a bonded abrasive article according to the fourteenth embodiment, wherein the crushed abrasive particles are arranged according to a regular pattern.

In a sixteenth embodiment, the present disclosure provides a bonded abrasive article according to the fourteenth or fifteenth embodiment, wherein the crushed abrasive particles have a non-random orientation.

In a seventeenth embodiment, the present disclosure provides a bonded abrasive article according to any of the fourteenth to sixteenth embodiments, wherein the binder material comprises a cured organic resin.

In an eighteenth embodiment, the present disclosure provides a bonded abrasive article according to any of the fourteenth to seventeenth embodiments, wherein the binder material comprises a vitreous binder.

In a nineteenth embodiment, the present disclosure provides a bonded abrasive article according to any of the fourteenth to eighteenth embodiments, wherein the bonded abrasive article comprises a bonded abrasive wheel.

In a twentieth embodiment, the present disclosure provides a bonded abrasive article according to any of the fourteenth to nineteenth embodiments, wherein the bonded abrasive article comprises a cutoff wheel.

In a twenty-first embodiment, the present disclosure provides a bonded abrasive article according to the twentieth embodiment, wherein the cutoff wheel further contains at least first and second reinforcing scrims disposed proximate respective opposed major surfaces of the cutoff wheel.

In a twenty-second embodiment, the present disclosure provides a bonded abrasive article according to any of the fourteenth to twenty-first embodiments, further comprising filler abrasive particles.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Table 1, below, lists various materials used in the examples.

TABLE 1

| ABBREVIATION | DESCRIPTION |
|---|---|
| AP1 | fused alumina-zirconia eutectic crushed abrasive particles, ANSI grade |
| | 24, obtained from Imerys Fused Minerals Villach GmbH, Villach, |
| | Austria |
| AP2 | FRSK, semi-friable brown fused alumina particles, ANSI 54, obtained |
| | from Imerys Fused Minerals Villach GmbH, Villach, Austria |
| AP3 | BRFPL heat-treated semi-friable fused aluminum oxide particles, ANSI |
| | P80, obtained from Imerys Fused Minerals Villach GmbH, Villach, |
| | Austria |
| RP | liquid phenolic resin obtained as PREFERE 92 5136G1 from Dynea |
| | Erkner GmbH, Erkner, Germany |
| PP1 | a mixture of 39.4% of novolac phenolic resin (obtained as HEXION |
| | 0224P from Momentive Specialty Chemicals Columbus, Ohio), 8.2% of |
| | silicon carbide (obtained as SIKA (75-99% silicon carbide CAS 409-21- |
| | 2) from Saint-Gobain Ceramic Materials AS, Cologne, France), 0.4% of |
| | carbon black (obtained as LUVOMAXXX LB/S from Lehmann & Voss |
| | & Co. KG Hamburg, Germany), and 52.0% of PAF (potassium |
| | aluminum fluoride from KBM Affilips Master Alloys, Delfzijl, |
| | Netherlands) |
| PP2 | a mixture of 39.6% of novolac phenolic resin (obtained as HEXION |
| | 0224P from Momentive Specialty Chemicals Columbus, Ohio), 8.2% of |
| | ZWSK F400 (obtained from Imerys Fused Minerals Villach GmbH, |
| | Villach, Austria) from Saint-Gobain Ceramic Materials AS, Cologne, |
| | France and 52.2% of PAF (potassium aluminum fluoride from KBM |
| | Affilips Master Alloys, Delfzijl, Netherlands) |
| SCRIM | fiberglass mesh scrim attached to a cloth mesh, obtained as RXV08-125 × |
| | 23 mm from Rymatex Sp. zo.o, Rymanow, Poland |

### Cutting Test Method

A 40-inch (1 m) long sheet of ⅛ inch (3.2 mm) thick stainless steel was secured with its major surface inclined at a 35-degree angle relative to horizontal. A guide rail was secured along the downward-sloping top surface of the inclined sheet. A DeWalt Model D28114 4.5-inch (11.4-cm)/5-inch (12.7-cm) cutoff wheel angle grinder was secured to the guide rail such that the tool was guided in a downward path under the force of gravity. A cutoff wheel for evaluation was mounted on the tool such that the cutoff wheel encountered the full thickness of the stainless steel sheet when the cutoff wheel tool was released to traverse downward, along the rail under gravitational force. The cutoff wheel tool was activated to rotate the cutoff wheel at 10000 rpm, the tool was released to begin its descent, and the length of the resulting cut in the stainless steel sheet was measured after 60 seconds. Dimensions of the cutoff wheel were measured before and after the cutting test to determine wear.

### Preparative Example 1

Preparative Example 1 describes the selection and analysis of AP1. A Camsizer XT by Retsch Technology GmbH was used to determine the ratio b/l (breadth divided by length) of the bulk AP1 sample. This sample was called AP1-Bulk. The ratio b/l is calculated as

$$b / l = \frac{{x}_{c , min}}{{x}_{Fe , max}}$$

where x_{c,min} is the shortest chord of the measured set of maximum chords of a particle projection and x_{Fe,max} is the longest Feret diameter out of the measured set of Feret diameters x_{Fe}.

A positioning tool 210, as shown in FIG. 2A, having precisely spaced and oriented equilateral triangular pockets with length of 1.90 mm/side with sidewall angles of 98 degrees relative to the bottom of each cavity, and a mold cavity depth of 0.0138 inch (0.35 mm) arranged in a radial array (all apexes pointing toward the perimeter) was then filled with AP1 assisted by tapping. Crushed abrasive particles in excess of those accommodated into the tool's cavities were removed by shaking and tapping.

The Camsizer XT was used to determine the ratio b/l of the AP1 sample that was selected by positioning tool 210. This sample was called AP1-Sorted. The results showed that the mineral that had been collected in the pockets had a 29% higher length vs. breadth (l/b, reciprocal of b/l determined as above) aspect ratio than the bulk sample. The higher the l/b value, the sharper the particles are considered to be.

Table 2, below, reports average aspect ratios of the bulk and sorted crushed abrasive particles.

TABLE 2

| Bulk Sample | Sorted Sample | AP-Bulk l/b | AP-Sorted l/b |
|---|---|---|---|
| AP1-Bulk | AP1-Sorted | 1.5018 | 1.9345 |

### Example 1

Preparative Example 1 describes the selection ability of AP1 and then Example 1 describes the preparation of a resin bonded abrasive wheel using AP1 and positioning tool 210, as shown in FIG. 1.

RP (50 grams) was added to 550 grams of AP2 and was mixed in a KitchenAid Commercial mixer (Model KSM C50S) for 7 minutes at speed 1. This mixture was then combined with 400 grams of PP1 and mixed for an additional 7 minutes. The resulting mix was then sieved using 14-mesh screens to remove clumps of binder and abrasive particles. The mixture will here on out be referred to as MIX1.

MIX1 (22 g) was placed in the bottom of a 5-inch (127-mm) diameter×1-inch (2.5-cm) deep metal mold cavity and spread to even thickness by a blade while the mold rotates. The mold had an inner diameter of 23-mm. The mold was closed and the MIX1 was pressed at a load of 50 tons (907 kg) at room temperature for 3 sec. After pressing, the MIX1 is a green-body wafer which was able to be handled.

A positioning tool 210, as shown in FIG. 2A, having precisely spaced and oriented equilateral triangular pockets with length of 1.90 mm/side with sidewall angles of 98 degrees relative to the bottom of each cavity, and a mold cavity depth of 0.0138 inch (0.35 mm) arranged in a radial array (all apexes pointing toward the perimeter) was then filled with AP1 assisted by tapping. Crushed abrasive particles in excess of those accommodated into the tool's cavities were removed by shaking and tapping.

A 125 mm diameter disc of fiberglass mesh RXV08-125×23 mm, further referred to as a SCRIM, was coated with a 67% weight percent solution of RP in isopropanol using a “Preval Sprayer” aerosol sprayer. The solution was made by combining 50 grams RP in 15 grams of isopropanol. The coating on the mesh was allowed to air dry for 10 minutes to allow the coating to become tacky. A reduced pressure source was turned on and the positioning tool was turned upside down while maintaining a single particle in the majority of cavities. Abrasive particles in excess of those accommodated into the tool's cavities were also removed in this way. The crushed abrasive particle-containing tool was then brought to close proximity, approximately 1 mm, to the adhesive coated disc and inverted to deposit the abrasive particles in a precisely arranged and oriented pattern on the adhesive coated disc. A total of 1.25 to 1.40 grams (g) of AP1 were applied.

A second 125 mm diameter scrim was identically coated with particles. After both scrims dried overnight, the second coated scrim was placed in the bottom of a 5-inch (127-mm) diameter×1-inch (2.5-cm) deep metal mold cavity, coated side up. The mold had an inner diameter of 23-mm. The green-body wafer of MIX1 was then placed on top of the coated scrim. The first scrim was then placed on top of the fill mixture, coated side down. A metal flange 28 mm×22.45 mm×1.2 mm from Lumet PPUH in Jaslo, Poland was placed on top of the first scrim. The mold was closed and the coated scrim-MIX1 wafer-coated scrim sandwich was pressed at a load of 30 tons (544.2 kg) at room temperature for 3 sec. The cutoff wheel precursor was then removed from the mold and cured in a stack with a 30 hour (hr) cure cycle: 2 hrs at 75° C., 2 hrs at 90° C., 5 hrs at 110° C., 3 hrs at 135° C., 3 hrs at 188° C., 13 hrs at 188° C., and a then 2 hrs cool down to 60° C. The final thickness of the wheel was in the range of 0.048 to 0.056 inch. Three replicates of Example 1 were made for a total of 3 wheels.

### Comparative Example A

Example 1 was repeated, except that the AP1 was not oriented on either scrim. To attach the non-oriented mineral, SCRIM was coated with a 67% weight percent solution of RP in isopropanol with an aerosol sprayer. The solution was made by combining 50 grams RP in 15 grams of isopropanol. All but the outer 1 inch (2.54 cm) of the scrim was covered with a paper. AP1 mineral was sprinkled onto the outer 1 inch (2.54 cm) of scrims while the scrim was rotated. The paper covering was removed. Two replicates of Comparative Example A were made for a total of 3 samples.

### Comparative Example B

Example 1 was repeated, except that the no AP1 or RP was placed on either scrim and the fill mixture wafer was 27 grams. Two replicates of Comparative Example B were made for a total of 3 samples.

### Example 2

Preparative Example 1 describes the selection ability of AP1 and then Example 1 describes the preparation of a resin bonded abrasive wheel using AP1 and positioning tool 210.

RP (60 grams) was added to 600 grams of AP3 and was mixed in a KitchenAid Commercial mixer (Model KSM C50S) for 7 minutes at speed 1. This mixture was then combined with 340 grams of PP2 and mixed for an additional 7 minutes. The resulting mix was then sieved using 14-mesh screens to remove clumps of binder and abrasive particles. The mixture will here on out be referred to as MIX2.

A 125 mm diameter disc of fiberglass mesh RXV08-125×23 mm, further referred to as a SCRIM was placed in the bottom of a 5-inch (127-mm) diameter×1-inch (2.5-cm) deep metal mold cavity. The mold had an inner diameter of 23-mm.

MIX2 (11 g) was placed and spread to even thickness by a blade while the mold rotates. The mold was closed and the MIX2 was pressed at a load of 5 tons (90.7 kg) at room temperature for 3 sec before the top of the mold was removed. After pressing, the MIX2 is a green-body wafer which has some stability.

A positioning tool 210, as shown in FIG. 2A, having precisely spaced and oriented equilateral triangular pockets with length of 1.90 mm/side with sidewall angles of 98 degrees relative to the bottom of each cavity, and a mold cavity depth of 0.0138 inch (0.35 mm) arranged in a radial array (all apexes pointing toward the perimeter) was then filled with AP1 assisted by tapping. Crushed abrasive particles in excess of those accommodated into the tool's cavities were removed by shaking and tapping.

A reduced pressure source was turned on and the positioning tool was turned upside down while maintaining a single particle in the majority of cavities. Abrasive particles in excess of those accommodated into the tool's cavities were also removed in this way. The crushed abrasive particle-containing tool was then inverted and brought to close proximity, approximately 1 mm to the wafer of MIX2 within the 5-inch (127-mm) diameter metal mold. The reduced pressure source was turned off to deposit the abrasive particles in a precisely arranged and oriented pattern on the base of the mold cavity. A total of 1.25 to 1.40 grams (g) of AP1 were applied. The mold was closed and the contents were pressed at a load of 5 tons (90.7 kg) at room temperature for 3 sec before the top of the mold was removed. After pressing, AP1 is pressed within the MIX2 green-body wafer.

Another 11 g of MIX2 was placed within the same mold and spread to even thickness by a blade while the mold rotates. The mold was closed and the MIX2 was pressed at a load of 5 tons (90.7 kg) at room temperature for 3 sec before the top of the mold was removed.

Another layer of oriented AP1 was precisely placed on top of the green-body wafer of MIX2. Just as in placement of the first layer of AP1, the second layer of AP1 was placed by utilizing the same process of a reduced pressure source and tooling with cavities. Another SCRIM was placed on top of the oriented AP1. The mold was closed and contents were pressed at a load of 30 tons (544.2 kg) at room temperature for 3 sec before the entire mold was removed. The final cut-off wheel precursor was a SCRIM-MIX2-AP1(Oriented)-MIX2-AP1(Oriented)-SCRIM sandwich.

The cutoff wheel precursor was then removed from the mold and cured in a stack with a 30-hour (hr) cure cycle: 2 hrs at 75° C., 2 hrs at 90° C., 5 hrs at 110° C., 3 hrs at 135° C., 3 hrs at 188° C., 13 hrs at 188° C., and then 2 hrs cool down to 60° C. The final thickness of the wheel was in the range of 0.42 to 0.55-inch (1.07 to 1.40 mm). Two replicates were made for a total of three wheels.

### Comparative Example C

Example 2 was repeated, except that the AP1 was not oriented on either scrim. AP1 (1.25 g) was sprinkled—random orientation—onto the outer 1-inch (2.54 cm) of each MIX2 for a total of 2.5 g AP1. The final cut-off wheel precursor was a SCRIM-MIX2-AP1(Random)-MIX2-AP1(Random)-SCRIM sandwich. Two replicates of Comparative Example C were made for a total of 3 samples.

Table 3, below, lists results obtained according to the CUTTING TEST METHOD for various of the above Examples.

TABLE 3

| | ONE MINUTE | | PERFORMANCE |
|---|---|---|---|
| | CUT, | WEAR RATE, | (Cut rate/wear rate) |
| EXAMPLE | mm/min | cm³/minute | (in/cm³) |
| Example 2 | 381, 406, 406 | 9952, 10257, 10043 | 0.038, 0.040, 0.040 |
| Comparative | 254, 279, 305 | 7645, 9477, 11326 | 0.033, 0.029, 0.027 |
| Example C | | | |

Orientation of AP1 aids in the one minute cut speed and ultimately improves performance. By orienting the sharper part of the grain towards the workpiece, it cuts faster and breaks down more than when utilizing the flat portion of a grain.

All cited references, patents, and patent applications in the Detailed Description and Examples sections of the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1-22. (canceled)

23. A method of making a bonded abrasive article, the method comprising sequentially performing steps:
a) providing a tool having first and second opposed horizontal major surfaces, the first major surface defining precisely-shaped cavities, wherein each horizontally-oriented precisely-shaped cavity has a predetermined location with respect to the surface of the tool, wherein each precisely-shaped cavity has a horizontal bottom surface with a respective conduit opening fluidly connected to a vacuum source;
b) urging first crushed abrasive particles with agitation against the surface of the tool, thereby causing a portion of the first crushed abrasive particles to become retained within at least some of the precisely-shaped cavities and causing a second portion of the first crushed abrasive particles to remain as first loose particles on the surface of the tool;
c) separating substantially all of the first loose particles from the tool;
d) positioning the tool within a mold containing a curable binder material precursor;
e) releasing the first crushed abrasive particles retained in the precisely-shaped cavities into the mold;
f) removing the tool from the mold;
g) compressing the first crushed abrasive particles and the curable binder material precursor to form a shaped green body; and
h) at least partially curing the curable binder material precursor to produce the bonded abrasive article.

24. The method of claim 23, wherein in step d) the mold further contains a first reinforcing scrim.

25. The method of claim 23, further comprising contacting wherein the precisely-shaped cavities are horizontally-oriented.

26. The method of claim 23, wherein substantially all of the horizontally-oriented precisely-shaped cavities contain at most one of the first crushed abrasive particles.

27. The method of claim 23, further comprising, after step e) and prior to step f), sequentially performing steps:
i) urging second crushed abrasive particles with agitation against the surface of the tool, thereby causing a portion of the second crushed abrasive particles to become retained within at least some of the precisely-shaped cavities and causing a portion of the second crushed abrasive particles to remain as second loose particles on the surface of the tool, wherein substantially all of the precisely-shaped cavities contain at most one second crushed abrasive particle;
ii) separating the second loose particles from the tool;
iii) adding an additional amount of the curable binder material precursor into the mold;
iv) positioning the tool within the mold; and
v) releasing the second crushed abrasive particles retained in the precisely-shaped cavities into the mold.

28. The method of claim 27, wherein the mold further contains a second reinforcing scrim.

29. The method of claim 23, wherein step b) comprises mechanically agitating the tool.

30. The method of claim 23, wherein the first crushed abrasive particles conform to an abrasives industry specified nominal grade prior to disposing them on the surface of the tool.

31. The method of claim 30, wherein the first crushed abrasive particles conform to an abrasives industry specified nominal grade selected from the group consisting of ANSI grade designations ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600; FEPA grade designations P8, P12, P16, P24, P36, P40, P50, P60, P80, P100, P120, P150, P180, P220, P320, P400, P500, P600, P800, P1000, and P1200; and JIS grade designations JIS8, JIS12, JIS16, JIS24, JIS36, JIS 46, JIS 54, JIS 60, JIS 80, JIS 100, JIS 150, JIS 180, JIS 220, JIS 240, JIS 280, JIS 320, JIS 360, JIS 400, JIS 600, JIS 800, JIS 1000, JIS 1500, JIS 2500, JIS 4000, JIS 6000, JIS8000, and JIS 10000.

32. The method of claim 31, wherein the first crushed abrasive particles comprise at least one of fused aluminum oxide, co-fused alumina-zirconia, ceramic aluminum oxide, green silicon carbide, black silicon carbide, chromia, zirconia, flint, cubic boron nitride, boron carbide, garnet, sintered alpha-alumina-based ceramic, and combinations thereof.

33. The method of claim 23, wherein the first crushed abrasive particles have an average particle diameter D₅₀ of at least 0.1 millimeter.

34. The method of claim 23, wherein the bonded abrasive article comprises a cutoff wheel.

35. The method of claim 23, wherein the curable binder material precursor comprises a curable organic resin.

36. A bonded abrasive article comprising crushed abrasive particles securely retained in a binder material, wherein the crushed abrasive particles are disposed at predetermined locations in the bonded abrasive article.

37. The bonded abrasive article of claim 36, wherein the crushed abrasive particles are arranged according to a regular pattern.

38. The bonded abrasive article of claim 36, wherein the crushed abrasive particles have a non-random orientation.

39. The bonded abrasive article of claim 36, wherein the binder material comprises a vitreous binder.

40. The bonded abrasive article of claim 36, wherein the bonded abrasive article comprises a bonded abrasive wheel.

41. The bonded abrasive article of claim 36, wherein the bonded abrasive article comprises a cutoff wheel.

42. The bonded abrasive article of claim 41, wherein the cutoff wheel further contains at least first and second reinforcing scrims disposed proximate respective opposed major surfaces of the cutoff wheel.
